(19) United States
(12) Patent Application Publication
(10) Pub. No.: US 2026/0036028 A1
(43) Pub. Date: Feb. 5, 2026

(54) Chemical Additive Trailer for Hydraulic Fracturing Operations

(71) Applicant: ProFrac Holdings II, LLC, Willow Park, TX (US)

(72) Inventors: Brandon N. Hinderliter, Porter, TX (US); Corey Donaldson, Weatherford, TX (US)

(73) Assignee: ProFrac Holdings II, LLC, Willow Park, TX (US)

(21) Appl. No.: 18/789,345

(22) Filed: Jul. 30, 2024

(51) Int. Cl. E21B 43/26

(52) U.S. Cl. CPC E21B 43/2607

(57) ABSTRACT

In a general aspect, chemical additives are provided for a hydraulic fracture treatment. In some cases, a method for providing chemical additives includes operating a chemical pump of at least one chemical pump installed on a chemical additive trailer to pump chemical additives from at least one chemical source to at least one blender trailer. A chemical additive is received from a chemical source at a pump inlet of the chemical pump. The chemical additive is discharged at a specified chemical additive flow rate. The specified chemical additive flow rate is below, for example, 0.165 gallons per minute. The chemical additive is provided from the pump outlet to a blender trailer for addition to a fracturing slurry. At least one electric motor is operated to drive the at least one chemical pump. At least one variable frequency drive is operated to control the at least one electric motor.

### TECHNICAL FIELD

The following description relates to a chemical additive trailer for hydraulic fracturing operations.

### BACKGROUND

Hydraulic fracture treatments can be used to stimulate the production of hydrocarbon resources (e.g., oil, natural gas, etc.) from subterranean rock formations. During a fracture treatment, fracture treatment fluids are pumped under high pressure into the subterranean rock formation through a wellbore to fracture the formation and increase permeability and production from the formation. The fracture treatment fluid may include, for example, proppants and chemical additives that give the fracture treatment fluid certain properties.

### DESCRIPTION OF DRAWINGS

FIG. 1 is a block diagram showing an example arrangement of components of a hydraulic fracturing system at a well site.

FIG. 2 is a system diagram showing an example chemical additive system.

FIG. 3 is a block diagram showing an example chemical additive system.

FIG. 4 is a perspective view showing an example chemical additive trailer.

FIG. 5 is a flow chart showing aspects of an example process of pumping chemical additives.

FIG. 6 is a block diagram showing an example computer system.

### DETAILED DESCRIPTION

In some aspects of what is described here, a chemical additive system operates to pump chemical additives from a chemical source for addition to a fracturing slurry. In some aspects, the chemical additive system includes a chemical additive trailer. In some aspects, the chemical additive trailer includes chemical pumps, electric motors, and variable frequency drives (VFDs). For instance, the electric motors are configured to drive the chemical pumps to pump the chemical additives, and the VFDs are configured to control the electric motors that drive the chemical pumps. In some aspects of what is described, the chemical additive system discharges chemical additives to a blender trailer (or other external unit or store of fracturing slurry) of a hydraulic fracturing operation at a well site. In some implementations, the chemical additive systems and techniques described here can be used to pump chemical additives at low flow rates including, for example, flow rates below 0.165 gallons per minute.

The chemical additive systems and techniques described here can provide technical advantages and improvements over conventional systems in some cases. For example, the systems and techniques described here can allow pumping of chemical additives at flow rates lower than conventional systems. This can provide benefits such as allowing the use of the chemical pumping system in a wider range of operating conditions where conventional systems are not able to be used. The chemical additive systems and techniques described here can provide benefits such as allowing smooth and continuous chemical pumping of chemical additives during operation in the supported range of operating conditions, which can simplify blending operations and enable easier real-time adjustments to chemical additive or fracturing slurry flow rates. The chemical additive systems and techniques described here can provide benefits such as allowing the use of chemical additive sources with higher concentrations due to the ability to pump the additives at low flow rates. For example, using higher concentration chemical additives can allow an operator to require a proportionally lower volume of chemicals at a well site, which can reduce the physical space needed for chemical additive storage and reduce the weight of the chemicals, both of which can allow more efficient well site layout and decrease the cost of transportation to the well site. The chemical additive systems described here can also provide the benefit of being highly mobile and maneuverable. For example, the chemical additive systems described here can have a smaller footprint than conventional systems and can be mounted to a trailer chassis for easy transport.

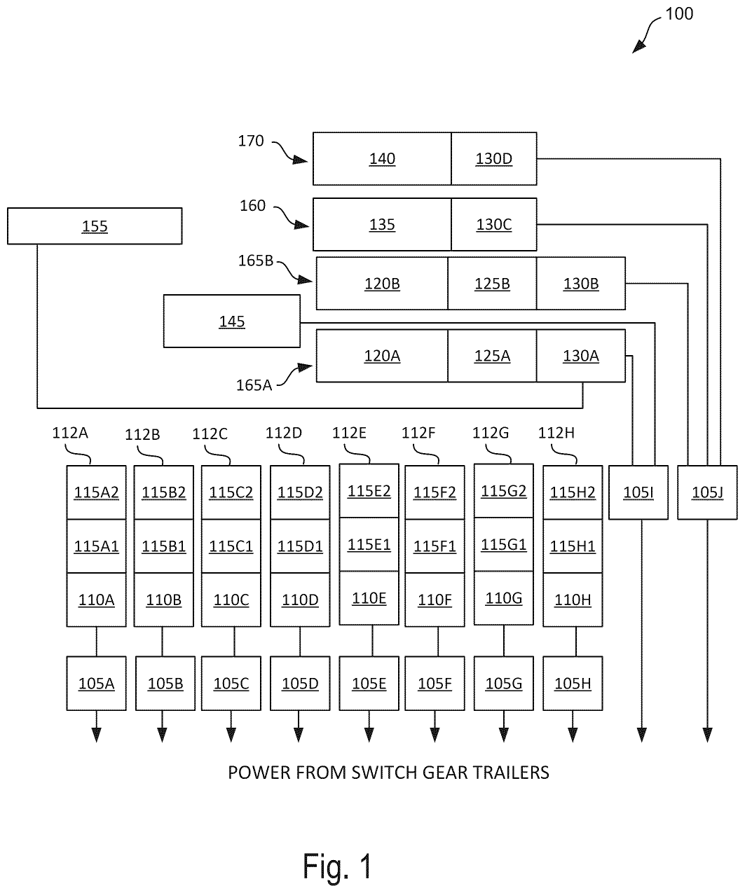

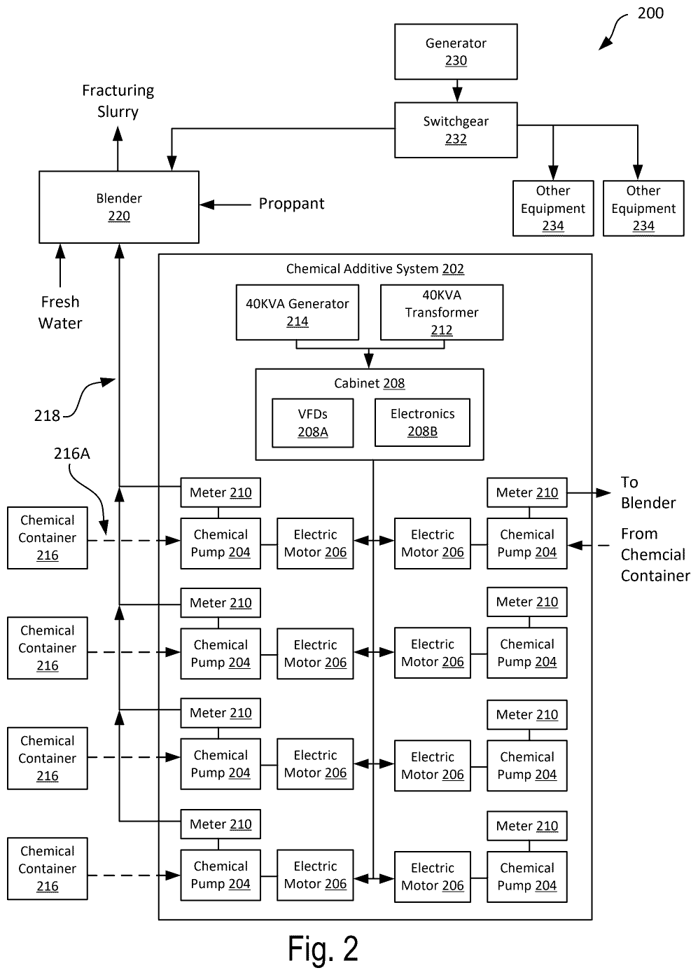

FIG. 1 shows an overhead schematic view of an example of a hydraulic fracturing system 100 arrangement at a well site. In the illustrated example, power (e.g., up to about 13.8 kilovolts (kV) or more) can be supplied from a plurality of switchgear trailers (not shown) to a plurality of transformers 105A, 105B, 105C, 105D, 105E, 105F, 105G, 105H. The transformers 105A, 105B, 105C, 105D, 105E, 105F, 105G, 105H can supply power at a stepped-down voltage of down to about 600V or less to a plurality of variable frequency drive (VFD) houses 110A, 110B, 110C, 110D, 110E, 110F, 110G, 110H. The VFD housings 110A, 110B, 110C, 110D, 110E, 110F, 110G, 110H can each include one or more VFDs that in turn control power provided to a plurality of fracturing pumps 115A1, 115A2, 115B1, 115B2, 115C1, 115C2, 115D1, 115D2, 115E1, 115E2, 115F1, 115F2, 115G1, 115G2, 115H1, 115H2. Reference to a VFD housing should be understood to be interchangeable with and also refer to one or more VFDs (e.g., within a housing, that includes the VFD, such as cabinet 208 of FIG. 2) (e.g., 208A of FIG. 2), unless explicitly noted otherwise.

Each of the transformers, VFD housings, and fracturing pumps can be housed on a plurality of fracturing pump trailers 112A, 112B, 112C, 112D, 112E, 112F, 112G, 112H, arranged parallel with respect to each other, as in the illustrated embodiment. In other embodiments, the plurality of trailers may be arranged perpendicularly, in series, or in any other arrangement suitable for the hydraulic fracturing operation. In some embodiments, each VFD housing 110A,110B, 110C, 110D, 110E, 110F, 110G, 110H is positioned on a trailer with two fracturing pumps 115A1, 115A2, 115B1, 115B2, 115C1, 115C2, 115D1, 115D2, 115E1, 115E2, 115F1, 115F2, 115G1, 115G2, 115H1, 115H2 positioned thereon, while the transformers 105A, 105B, 105C, 105D, 105E, 105F, 105G, 105H are positioned on separate trailers. In other embodiments, other combinations of transformers, VFD housings, and fracturing pumps can be arranged on one or more trailers. Although illustrated in FIG. 1 as having eight sets of transformers, VFD housings, and fracturing pumps, in other implementations, any number (e.g., 1, 2, 3, 6, 9, 10, 12, or more) of each element can be included in the hydraulic fracturing system 100.

In some embodiments, fracturing pumps 115A1, 115A2, 115B1, 115B2, 115C1, 115C2, 115D1, 115D2, 115E1, 115E2, 115F1, 115F2, 115G1, 115G2, 115H1, 115H2 can include electric, diesel, or dual-fuel fracturing pumps. The diesel or dual-fuel fracturing pumps can be used to supplement an electric fleet (of electric fracturing pumps). For example, the diesel or dual-fuel fracturing pumps can be fluidly connected to and combined with the fluid output of electric fracturing pumps. Together, the electric and non-electric fracturing pumps can be used to provide power for fracturing the well.

In the illustrated embodiment, two additional transformers 105I, 105J receive power (e.g., up to about 13.8 kV or more) from a switchgear trailer and provide a stepped-down voltage of down to about 600V or less to sand equipment 145, a hydration unit 160, blenders 165A, 165B, and/or a chemical additive system 170. Power from transformers 1051, 105J can also be indirectly supplied to data van 155 via a VFD housing 130A, 130B of one or more blenders 165A, 165B, according to the illustrated embodiment. In some implementations, power is supplied directly to data van 155.

In typical, hydraulically-powered systems, two or more auxiliary trailers (not shown) would be included in the hydraulic fracturing system 100 to house the hydraulic equipment and related power equipment such as VFDs, soft starters, motor control centers (MCCs), and breakers, for example. In the illustrated example, the two transformers 1051, 105J are provided in lieu of the two auxiliary trailers, as bulky hydraulic motors may not be needed to power the ancillary equipment. The remaining equipment typically stored on the auxiliary trailers, such as the VFDs, soft starters, motor control centers, and breakers, can be relocated to the individual trailers housing each of the hydration unit 160, blenders 165A, 165B, and chemical additive system 170. For example, according to an embodiment of the present disclosure, the entire hydraulic system typically positioned on and used to power each piece of ancillary equipment in known hydraulically-powered systems can be removed and replaced with a VFD housing.

Since the required equipment for the auxiliary trailer is partially or entirely eliminated by the substitution of electric power for hydraulic power, the embodiment illustrated in FIG. 1 can allow for elimination of the auxiliary trailer. With each of the VFDs, soft starters, MCCs, and breakers moved to respective blender 165A, 165B and hydration unit 160 trailers, the auxiliary trailer can be replaced with one or more transformers 1051, 105J.

Replacing the two typical auxiliary trailers with two 13.8 kV to 600V transformers 105I, 105J can conserve space at the hydraulic fracturing well site 100. The mixing equipment composed of two blenders 165A, 165B, a hydration unit 160, and a chemical additive system 170 can each include a VFD housing 130A, 130B, 130C, 130D, respectively, in place of where the hydraulic power equipment would have been positioned on each respective trailer, as discussed in more detail below.

In the illustrated example, the two blender units 165A, 165B can be powered through separate transformers 1051, 105J. This configuration can provide redundancy such that if one switchgear, turbine, or transformer has a failure, the other blender will still be operational for flushing the wellbore and maintaining circulation.

According to an embodiment, blenders 165A, 165B can operate very similarly to a fracturing pump, with only a transformer 105I, 105J supplying power to the trailer on which each blender 165A, 165B is positioned, and with all supporting breakers and controls being locally positioned at blenders 165A, 165B. These transformers 1051, 105J can be small, skid-mounted enclosures that can be positioned close to the blenders 165A, 165B at the hydraulic fracturing system 100 well site, and can include connections for two or more pieces of equipment. Each connection can include six cables plus a ground cable, according to an embodiment, where the six cables are composed of two cables for each of the three power phases. In other embodiments, other numbers and combinations of cables, ground cables, and power phases can be used.

Typical electric motors may use 600V, three-phase electrical power, according to some embodiments. Alternate embodiments may use 4160V, 480V, or any other feasible three-phase voltage instead. Single-phase alternating current (AC) voltage can be used as well, with voltages including but not limited to 120V or 240V. In some embodiments, DC voltage, for example having simplified controls (e.g., lack of a VFD) can be used for smaller motors, at voltages including 5V, 12V, 24V, 48V, or any other reasonable DC voltage.

In the illustrated example, hydration unit 160 includes a trailer positioned to house mixing vessels and fluid pumps 135 and a VFD housing 130C. For example, the hydration unit 160 can hold up to 300 barrel units (bbl) of fluid in a mixing vessel 135, according to an embodiment, and between 200 bbl to 225 bbl of fluid according to another embodiment. The hydration unit 160 can supplement the capabilities of the blenders 165A, 165B by pulling on fluid through a suction manifold. Typically, fluid pulling is provided by a hydraulically powered fluid pump; however, in an embodiment according to the present disclosure, fluid pulling can be provided instead by an electrically powered fluid pump. The electric motor operating the fluid pump can be positioned on the trailer housing hydration unit 160, for example between the mixing vessels and pumps 135 and VFD housing 130C in an embodiment, or under the VFD housing 130C in another embodiment.

The mixing vessel 135 of hydration unit 160 can be used to premix chemicals for use in hydraulic fracturing operations and can act as a buffer in the event of a fluid delivery problem. For example, if a fracturing stage is being pumped at a fluid rate of 70 barrels per minute (bpm) when water transfer to the well site is lost, the mixing vessel 135 can provide operators with a three-minute window to determine the problem causing the lost water transfer and to resume water transfer, or to flush the surface equipment and shut down pumping operations.

The mixing vessel 135 can include an instrumentation and control package, which can allow the mixing vessel 135 to monitor, for example, any of fluid rate, pressure, viscosity, pH, temperature, and chemical additive rates in either automatic or manual modes of operation. All valves, paddles, and pumps associated with the mixing vessel 135 can be controlled and powered through an onboard circuit positioned on the trailer housing hydration unit 160.

A plurality of small electric motors can be used with various components associated with the hydration unit 160. For example, an electric motor can be used to rotate mixing paddles in a large mixing compartment of the hydration unit 160, while another electric motor can be used with a suction manifold to pull of the fluid, and still another electric motor can be used for driving the chemical pumps associated with the hydration unit 160. Each electric motor can be positioned at various discrete positions about the hydration unit 160 trailer in some embodiments, or can be clustered in other embodiments.

Chemical additive system 170 can include a trailer positioned to house chemical pumps 140 and VFD housing 130D. In some embodiments, a fracturing fleet can utilize four or five chemical pumps, depending on the particular needs of the fracturing site, or consumer requirements. In some embodiments, the blender units 165A can include five to eight chemical pumps, although in other embodiments, one, two, three, four, nine, ten, or more chemical pumps can be included. In some embodiments, the hydration units 160 can additionally include five or more chemical pumps, although in other embodiments the hydration units 160 can include zero, one, two, three, or four chemical pumps, depending on particular fracturing site requirements or consumer preferences. In some embodiments, where both the blender units and the hydration units include chemical pumps, either the blender units 165A or the hydration units 160 can provide all the chemicals needed for the fracturing slurry. In such embodiments, either the blender units 165A or the hydration units 160 can serve as the primary chemical delivery method. Because of this redundancy, if either the blender unit or the hydration unit has a pump failure, the other, functioning unit can serve as a backup to provide the chemicals needed for the fracturing slurry. Thus, in some implementations, the blender units 165A, 165B can also contain chemical pumps 125A, 125B, such that the hydration unit 160 can serve as either the backup chemical delivery system to the chemical delivery system of the blender units 165, or as the primary chemical delivery system. This backup chemical delivery system may be advantageous, for example, in use with certain chemicals. For example, guar gel (an example of a viscosifier) needs time and fluid shear to properly mix and thicken, and accordingly should be added to the slurry mixture at the hydration unit 160. If added at one or more of the blenders 165A, 165B, guar gel may not have sufficient time to mix, and may result in an improper slurry viscosity, leading to less than ideal well production after the fracturing process is completed.

In some embodiments, chemical additive system 170 can serve as the primary source of chemicals for the fracturing slurry. In other embodiments, chemical additive system 170 can serve as the secondary or tertiary source of chemicals, after the hydration unit 160 and/or blenders 165A, 165B. The chemical additive system 170 can include several chemical pumps and vats (e.g., containers), and can be used to supplement the blenders 165A, 165B, particularly when the hydraulic fracturing operation requires multiple different chemicals or a particular chemical pump redundancy. In some embodiments, up to a dozen or more chemical pumps can be used with chemical additive system 170. In some embodiments, the chemical pumps can be configured for use with liquid chemicals, while in other embodiments the chemical pumps can be dry chemical augers. In the latter case, a small hopper with a small, screw-type auger can pull the powder chemical from the hopper, and can drop the powder chemical into a mixing tub. Each blender can include one or more of these hopper and auger combinations, in some embodiments. In other embodiments, a larger dry chemical additive system can be incorporated into a hydration unit with a large mixing tub.

Like the hydration unit 160 and blenders 165A, 165B, the chemical additive system 170 can be designed to be operated without the use of hydraulics, instead employing electric motors. The substitution of electrical power for hydraulic power can provide multiple advantages, as previously discussed, including saving space, enhancing reliability and versatility, improving ecological impact, being lighter, quieter, and safer, presenting fewer fire hazards. Additional examples of chemical additive system 170 are described in more detail below, including the chemical additive systems 202 and 302 described with respect to FIGS. 2-5

The one or more chemical pump 140 of chemical additive system 170 can include one or more electric motor, which can be stacked between the VFD housing 130D and the chemical additive system 170 in some embodiments, or can be installed underneath the VFD housing 130D in other embodiments. The electric motors can be small enough to be positioned in various configurations around the chemical pump 140 trailer. The electric motors can operate components of the chemical pump 140 in lieu of the use of hydraulic power, the latter of which is typically provided from one or more auxiliary trailers.

Blenders 165A, 165B can include slurry mixing units 120A, 120B, pumps 125A, 125B, and VFD housings 130A, 130D. The slurry mixing units 120A, 120B and pumps 125A, 125B can each be electrically coupled to a respective electric motor to drive operation of the mixing units and pumps. In an embodiment, blenders 165A, 165B can further include a battery powered electric hopper raise/lower system to facilitate “spotting” the blender during rig-in. This raise/lower system can allow a proppant hopper to be lowered into place before turbine power is connected, so that operators can see where the hopper will rest in relation to a sand conveyor. With the introduction of electrically actuated valves according to the present disclosure, the raise/lower system can be tied into that battery system. This can allow the blender operator to open a manifold crossover in the event of an electrical failure (e.g., turbine shutdown, ground fault, cable disconnection, breaker opening, etc.). The manifold crossover can be a pipe that spans from the suction manifold to the discharge manifold, bypassing the mixing tub, discharge pump, and metering instrumentation. This configuration also provides an added operational backup, in which, if the primary blender loses power, the raise/lower system can still open the manifold crossover to allow the hydration unit 160 to boost water through the inoperable primary blender manifold to the secondary blender without shutting down the fracturing operation. This can prevent millions of dollars wasted during downtime by maintaining circulation in the well to prevent a “screen out,” in which additional nonproductive services such as coil tubing, flow back, or a workover rig will be required to clean out the well.

Attention is now directed to systems and techniques for pumping chemical additives. Some conventional chemical additive systems use diesel engines to drive chemical pumps for delivery of chemical additives to fracturing slurry. However, these conventional systems have several drawbacks due to the limitations imposed by diesel engines. Such conventional systems can be limited in how low of a fluid flow rate they can achieve, for example, due to the diesel engines needing to maintain a minimum rotational speed. To achieve lower flow rates some conventional systems must be operated according to a duty cycle where the chemical additive pump alternates between being on and off. However, operating the chemical additive pump in such a manner makes accurate and precise dosing of chemical additives difficult. As a result, conventional chemical additive systems are typically not used until the flow rate of the hydraulic fracturing slurry (e.g., into the wellbore) reaches at least 30-45 barrels per minute (bpm).

In some implementations, the chemical additive systems and techniques described here (e.g., with respect to FIGS. 2-5) can be used to pump chemical additives at low flow rates, for example, below 0.165 gallons per minute. For example, the systems and techniques described here have been successfully operated in a wide range of flow rates, from 0.084 gpm to 9.24 gpm. When deciding on chemical additive treatment for a fracturing slurry, an operator typically determines the amount of a chemical additive to add in units of gallons per thousand gallons (gpt) (e.g., gallons of chemical additive per thousand gallons of the mixed fracturing slurry). Being able to achieve low flow rates of down to 0.084 can allow an operator to use the chemical additive system at a fracturing slurry flow rate as low as 20 bpm (and up to 120 bpm) while maintaining the desired amount of chemical additive in gallons per thousand gallons of slurry. The result can be that an operator can begin chemical additive treatments earlier on in a hydraulic fracturing operation (e.g., while pumping into the wellbore and pressure builds), increasing the efficiency of the job. An example calculation is included below, showing that a chemical additive flow rate of 0.084 gpm at fracturing slurry pumping rate of 40 bpm allows chemical additive concentration of 0.05 gpt to be achieved. Likewise, a concentration of 0.1 gpt can be achieved for fracturing slurry pumping rate of 20 bpm.

$$\frac{0.05 gal}{1 kgal} \times \frac{40 barrels}{1 min} \times \frac{42 gal}{1 barrels} \times \frac{1 kgal}{1000 gal} = \frac{0.0 \; 84 gal}{min}$$

The chemical additive systems and techniques described here can allow smooth and continuous chemical pumping of chemical additives during operation in the supported range of operating conditions due to the use of electric motors controlled by VFDs, which can simplify blending operations and enable easier real-time adjustments to chemical additive or fracturing slurry flow rates. As discussed previously, conventional systems using diesel engines can require cycling the engine on and off to achieve lower flow rates. However, the electric motors of the chemical additive systems described here can operate smoothly and continuously at low rotational speeds, and thus at low chemical pumping rates, due to the capability of the electric motors and control of the VFDs.

The chemical additive systems and techniques described here can allow an operator to use chemical additive sources with higher concentrations. For example, to achieve a desired concentration of chemical additive (in gallons per thousand) in the fracturing slurry using conventional systems, an operator must use a lower source concentration of chemical additives because the flow rate of the chemicals into the slurry cannot be lowered beyond a certain point (e.g., 0.165 gpm). However, if chemical additive can be pumped at lower flow rates into the fracturing slurry, the operator can use a higher concentration source of chemical additives to achieve the same concentration of chemical additive in the fracturing slurry (in gallons per thousand). Further, using higher concentration chemical additives can allow an operator to require a proportionally lower volume of chemicals at a well site, which can reduce the physical space needed for chemical additive storage and reduce the weight of the chemicals, both of which can allow more efficient well site layout and decrease the cost of transportation to the well site.

The chemical additive systems described here can also provide the benefit of being highly mobile and maneuverable. For example, the chemical additive systems described here can have a smaller footprint than conventional systems and can be mounted to a trailer chassis for easy transport. Conventional systems relying on diesel engines were limited in how small they can be made due to the larger space requirements of diesel engines and accompanying fuel sources, which are mitigated by the use of electric motors.

FIG. 2 is a system diagram showing an example chemical additive system. As shown in FIG. 2, system diagram 200 includes chemical additive system 202 which is operatively connected to chemical containers 216, blender 220, and medium voltage switchgear 232. In some instances, the example chemical additive system 202 may be used at a well site for performing a hydraulic fracturing process.

As shown in FIG. 2, chemical additive system 202 includes chemical pumps 204. In some implementations, a chemical pump 204 is a positive displacement chemical pump. For example, a positive displacement pump is a type of pump used to move fluids from one place to another by trapping a fixed amount of fluid and then forcing that fluid into a discharge pipe or system. Positive displacement pumps can deliver a consistent and constant flow rate, regardless of changes in pressure or system resistance. In some embodiments, chemical pumps 204 include one or more other types of pumps for displacing fluid.

As shown in FIG. 2, chemical additive system 202 includes electric motors 206. In some implementations, an electric motor 206 is a component that converts electrical energy into mechanical energy. A wide variety of electric motors can be used in a chemical additive system 202 depending on the specific characteristics of the environment or operational demands. For example, an electric motor 206 can be selected based on one or more of its operational ratings such as power output, rotational speed, voltage rating, and phase. For instance, a 5 horsepower (HP) electric motor having a maximum rotational speed rating of 1750 revolutions per minute (RPM) can be used. In some implementations, electric motors 206 include motors having the same or different sizes (e.g., physical sizes or sizes of operational ratings). For example, electric motors 206 can include six 5 HP motors as described above and two 10 HP that are larger in physical size and larger in size of power output (and thus are of a different size than) the 5 HP motors. For instance, the 10 HP motors can be capable of generating higher torque or rotational speed than the 5 HP motors, and can be used under certain operational scenarios (e.g., for pumping high viscosity fluids such as viscosifiers).

As shown in FIG. 2, chemical additive system 202 includes cabinet 208. In some implementations, cabinet 208 includes VFDs 208A. In some implementations, VFDs are located outside of cabinet 208. VFDs 208A include one or more VFD that is used to control electric motors 206. For example, a VFD 208A is an electronic device used to control the speed and torque of an electric motor by varying the frequency and voltage of the electrical power supplied to the motor. VFDs can be used to achieve energy savings, precise control, and increased efficiency in motor-driven systems. In some implementations, a VFD 208A includes one or more of the following components: a converter, a direct current (DC) bus, an inverter, a control panel, and a feedback system. For example, VFD 208A includes a converter (or rectifier) at its input, which converts the incoming AC power from the power source into DC power which is then used in the next stages of the VFD. For example, the DC bus can act as an intermediate energy storage component, smoothing out fluctuations in the power supply and providing a stable source of DC power for the VFD's inverter stage. For example, the inverter converts the DC power from the DC bus back into variable-frequency AC power. In some implementations, VFD 208A controls the speed and torque of the connected electric motor by adjusting the frequency and voltage of this AC power output. For example, VFD 208A includes a control panel (or interface) that allows users to set and adjust various parameters, including motor speed, acceleration, deceleration, and direction of rotation. For example, VFD 208A includes a feedback system that includes sensors (or otherwise incorporates feedback from sensors) such as encoders or tachometers to measure the coupled motor's speed and adjust the output accordingly.

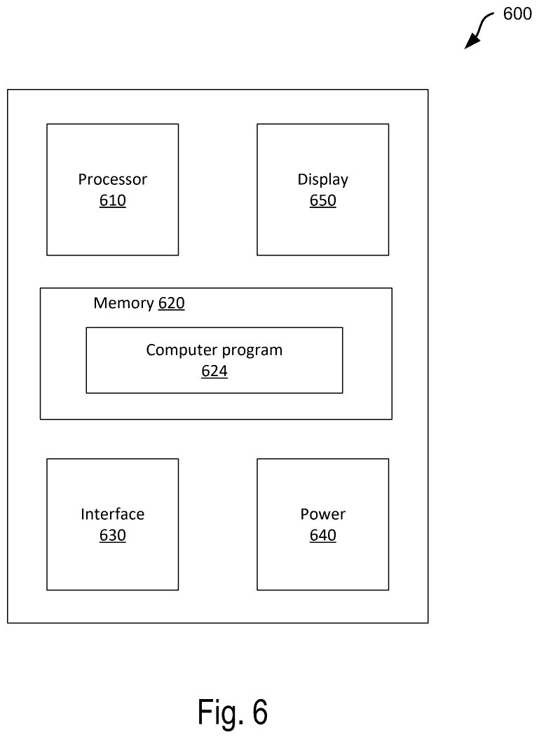

In some implementations, cabinet 208 includes electronics 208B used to control operations of the chemical additive system 202. For example, electronics 208B can include one or more control systems. In some implementations, the control systems can include one or more computing devices or systems (e.g., such as computer system 600 of FIG. 6) associated with one or more of the components shown in FIG. 2 (e.g., embodied in electronics 208B and optionally located in the cabinet 208). In some implementations, the control systems may include computing devices or systems that are separate from the components shown in FIG. 2 (e.g., some or all components of the control system are located external to chemical additive system 202 and in a data van, at a remote data center, or in the cloud). In some implementations, a control system can monitor and control the chemical additives supplied by the chemical additive system 202. The control system may receive data collected or generated by the chemical additive system 202, and the control system may process the data or otherwise use the data to select or modify operating parameters. For example, the control system may initiate control signals that configure or reconfigure components of the chemical additive system 202 or other equipment based on selected or modified properties.

In some implementations, chemical additive system 202 includes a housing (e.g., cabinet 208) installed on a chemical additive trailer (e.g., 410). For example, the housing houses the variable frequency drives (e.g., 208A) and electronics (e.g., 208B). In some implementations, chemical additive system 202 includes at least eight chemical pumps (e.g., 204) installed on the chemical additive trailer; the at least eight chemical pumps are configured to pump chemical additives from at least four distinct chemical sources (e.g., 216) to the at least one blender trailer (e.g., 220).

In some implementations, a control system includes one or more interfaces that enable an operator to set characteristics or parameters of the chemical additive system 202. For example, a control system can include a digital control panel that includes input and output devices (e.g., mouse, keyboard, display, and/or touchscreen display) usable by an operator to set and monitor chemical additive flow rates. For instance, the control panel can display real-time data and allow for adjustments as needed. In some implementations, the control system provides an interface to an external control system component. For example, the interface can allow remote monitoring and control for enhanced operational efficiency. In some implementations, the interface includes components enabling wired connectivity (e.g., Ethernet, coaxial, and/or fiber optic) and/or or wireless connectivity (e.g., 3G, 4G, LTE, 5G, 6G, and/or Wi-Fi).

In some implementations, cabinet 208 includes one or more power conversion components. For example, transformer 212 or generator 214 can output three phase 480V power in some implementations, and cabinet 208 can include converters for creating low voltage power for on-board electronics 208B.

In some implementations, chemical additive system 202 includes (or performs) one or more safety features. For example, chemical additive system 202 can include one or more leak detection sensors placed throughout the system to detect any leaks or abnormalities and trigger automatic shutdown if necessary. For example, chemical additive system 202 can include an emergency stop button that allows immediate cessation of chemical flow in case of emergencies.

As shown in FIG. 2, chemical additive system 202 includes flow meters 210. For example, flow meter 210 can measure the flow rate of chemical additives with sufficient accuracy and precision, even at low flow rates. In some implementations, a flow meter 210 can be required to measure flow rates from as low as 0.084 gallons per minute (gpm) to as high as 9.24 gpm. Flow meters 210 can be arranged and configured to measure the flow rate of chemical additives output from chemical pumps 204. As shown in FIG. 2, each chemical pump 204 can be configured with a respective flow meter 210 measuring the output of the pump. In some implementations, measurements of flow meters 210 are used as feedback in a closed loop control system (a feedback control loop) (e.g., to adjust control signals to a VFD for controlling a motor that drives a chemical pump). For example, electronics 208B can receive the measurements of flow meters 210 and cause VFDs 208A to adjust their output. In some cases, VFDs 208B receive output from the flow meters 210.

As shown in FIG. 2, chemical additive system 202 includes transformer 212. In FIG. 2, transformer 212 is a transformer rated at 40 kilo-volt-amperes (kVA), which is capable of providing enough power to the chemical additive system 202. Transformer 212 is connected to and receives input power from a generator 230 via a switchgear 232. In some implementations, generator 230 is a gas turbine that generates electricity for equipment at the well site (e.g., for chemical additive system 202, blender 220, and/or other equipment 234). Other types of generators can be used. In some implementations, transformer 212 receives input power from a utility source rather than an on-site generator. In some implementations, chemical additive system 202 does not include a transformer. For example, chemical additive system 202 can include generator 214 without including transformer 212.

As shown in FIG. 2, chemical additive system 202 includes generator 214. In FIG. 2, generator 214 is a generator rated at 40 kVA, which is capable of providing enough power to the chemical additive system 202. In some implementations, generator 214 is located on chemical additive system 202 and is used to generate electrical power for the components of chemical additive system 202. For example, if connection to an external power source (e.g., generator 230) is not available or not feasible, an operator has the option to use on-board generator 214 as a power source for operation of chemical additive system 202. In some implementations, generator 214 is a diesel generator, gas turbine, or another type of generator. In some implementations, chemical additive system 202 does not include a generator. For example, chemical additive system 202 can include transformer 212 without including generator 214. As shown in FIG. 2, chemical additive system 202 can include both transformer 212 and generator 214, which can provide an operator with different options for powering the system.

The input or output voltages of the power supply components (e.g., transformer 212 and generator 214) of chemical additive system 202 can depend on the needs of the operator and the components selected. For example, transformer 212 can be configured to use three phase input at 25 kilovolts (kV), 13.8 kV, 4160V, or 2000V at the primary side (e.g., from switchgear 232). For example, transformer 212 and/or generator 214 can be configured to supply three phase output at 4160V, 720V, 690V, 600V, or 480V, or to supply 240V split phase output. For example, if chemical additive system 202 includes both transformer 212 and generator 214, they can both be configured to output 480V to power all of the VFDs 208A (and thereby the motors and pumps) and onboard electronics 208B.

As shown in FIG. 2, chemical additive system 202 is connected to chemical containers 216 via chemical input connections 216A. For example, chemical input connections 216A can be connected to corresponding pump inlets of chemical pumps 204. During operation, chemical pumps 204 will pull chemical additives from chemical input containers 216 via chemical input connections 216A and output the additives at a specified flow rate via a pump outlet of the pump. Examples of chemical additives that can be pumped using chemical additive system 202 include surfactants (e.g., for reducing surface tension in liquids, making them effective in hydraulic fracturing), scale inhibitors (e.g., for preventing the formation of scale deposits in pipelines, equipment, and processes), clay stabilizers (e.g., for mitigating clay swelling and dispersion), and corrosion inhibitors (e.g., for protecting metal surfaces from corrosion). In some implementations, chemical pumps 204 are used to pump a viscosifier from chemical containers 216, such as a chemical or solution for increasing the viscosity of a fracturing slurry. In some implementations, chemical containers 216 are designed to withstand various chemical properties and are equipped with safety measures to prevent leaks and spills.

In some implementations, chemical containers 216 include containers that hold different chemicals. For example, a first chemical container (of chemical containers 216) can include a surfactant that is pumped by a first chemical pump (of chemical pumps 204) and a second chemical container (of chemical containers 216) can include a scale inhibitor that is pumped by a second, different chemical pump (of chemical pumps 204). In the scenario where chemical containers 216 includes different chemicals, each chemical can be pumped simultaneously and independently of each other. For example, a first chemical additive can be pumped at a first chemical additive flow rate and a second chemical additive can be pumped at a second, different chemical additive flow rate. In some implementations, multiple chemical pumps are connected to and supplied by a single chemical container 216.

In the example in FIG. 2, chemical containers 216 are external to chemical additive system 202. In some implementations, one or more chemical containers 216 are part of (e.g., located on) chemical additive system 202. For example, the compact and efficient footprint of the illustrated components of chemical additive system 202 and the ability to use higher concentration (and thus a lower volume) of chemicals can enable the chemical containers to be located on the same trailer as the VFDs, motors, and pumps.

As shown in FIG. 2, chemical additive system 202 is connected to blender 220 via chemical output connections 218. In some implementations, chemical output connections 218 represent the output (e.g., discharge) of the chemical pumps 204. In the example in FIG. 2, the chemical output connections 218 of each chemical pump 204 combine and flow to blender 220. In some implementations, one or more of chemical output connections 218 from respective chemical pumps 204 do not combine (e.g., flow independently to the blender). Blender 220 can also receive other inputs, such as of water and/or proppant, in addition to chemical additives from chemical additive system 202. In some implementations, blender 220 mixes these inputs together to form a fracturing slurry. This fracturing slurry can then be pumped down into the wellbore using several hydraulic fracturing pumps as described previously. In some implementations, blender 220 includes one or more of the features described above with respect to blender 165A or blender 165B (also variously referred to as blender unit or blender trailer). As used herein, reference to a blender, a blender unit, or a blender trailer can be interpreted as interchangeable with another component or unit that performs the same or similar functions. For example, a hydration unit (e.g., 160) can perform mixing of fluids and chemicals to supplement or replace functionality of a blender, as described above. Accordingly, one of ordinary skill in the art would recognize that, for example, providing chemical output to a blender (e.g., 220 in FIG. 2) can be understood to include “to” or “via” a hydration unit or other component for blending fracturing slurry components.

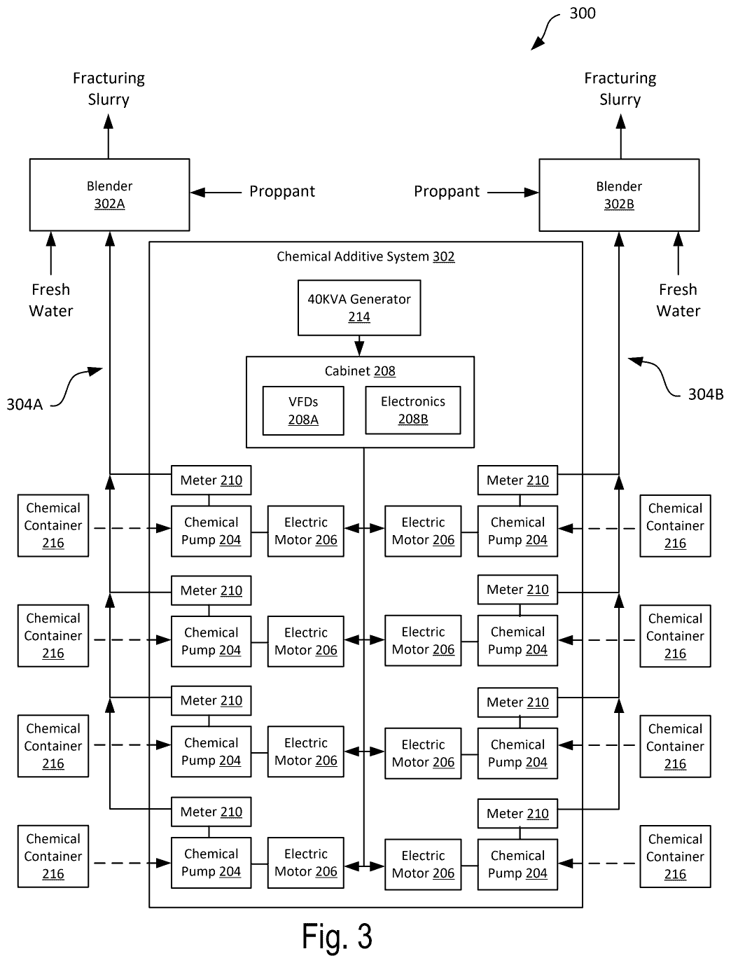

FIG. 3 is a system diagram showing an example chemical additive system. As shown in FIG. 3, system diagram 300 includes chemical additive system 302 which is operatively connected to chemical containers 216 (e.g., as described above). With the exception of the configuration differences noted below, the features and operations described above with respect to chemical additive system 202 apply equally to chemical additive system 302, and are hereby incorporated by reference. In FIG. 3, chemical additive system 302 is shown in a different configuration and operating context than chemical additive system 202 in FIG. 2. In the example in FIG. 3, chemical additive system 302 includes a generator (e.g., generator 214), but does not include a transformer, so power generation for VFDs, motors, and onboard electronics are generated onboard using the generator. In FIG. 3, chemical additive system 302 is used to pump chemical additive to two separate blenders: to a first blender 302A via a chemical output connection 304A and to a second blender 302B via a chemical output connection 304B. For example, chemical output connection 304A can be used to simultaneously output the same or different chemical additives than chemical output connection 304B. For instance, the chemical containers 216 supplying the respective pumps can include the same or different chemical additives.

In some implementations, chemical additive system 302 includes a housing (e.g., cabinet 208) installed on a chemical additive trailer (e.g., 410). For example, the housing houses the variable frequency drives (e.g., 208A) and electronics (e.g., 208B). In some implementations, chemical additive system 202 includes at least eight chemical pumps (e.g., 204) installed on the chemical additive trailer; the at least eight chemical pumps are configured to pump chemical additives from at least four distinct chemical sources (e.g., 216) to the at least one blender trailer (e.g., 302A, 302B).

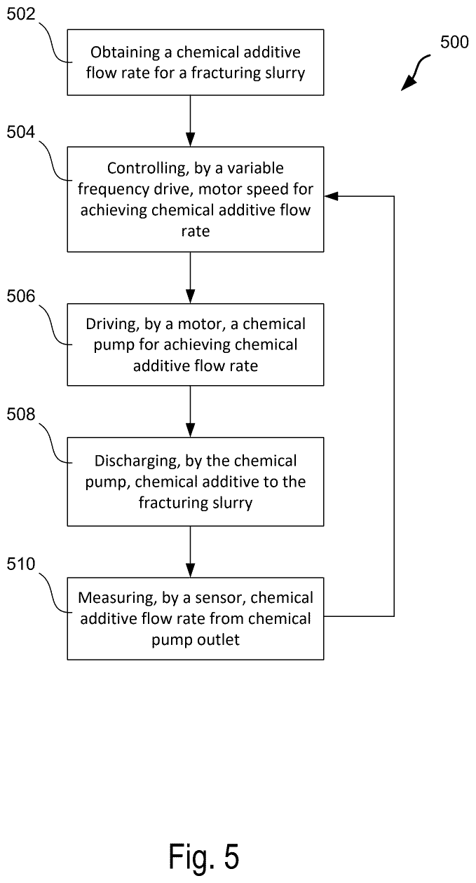

In some instances, a chemical additive system can be implemented as the example chemical additive systems 202 or 302 shown in FIGS. 2 and 3 or implemented in another manner. In some instances, the chemical additive system can perform one or more of the operations in the example process 500 shown in FIG. 5 or in another manner.

It should be noted that the operating configurations shown in the examples in FIGS. 2 and 3 are merely examples and should not be construed as strictly limiting the uses of configurations of a chemical additive system. For example, chemical additive system 202 or 302 can be configured to pump chemical additives to a different number of blenders using a different configuration of pumps (e.g., 6 pumps to one blender and 2 pumps to another blender).

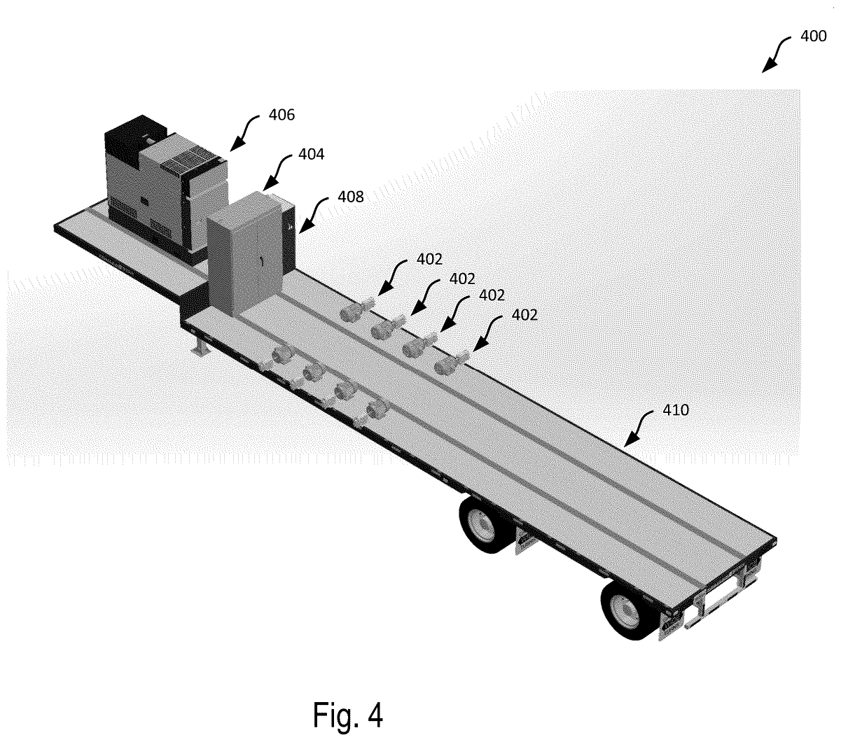

FIG. 4 is a perspective view showing an example chemical additive system. Chemical additive system 400 shown in FIG. 4 can include one or more of the features describe above, for example, with respect to chemical additive systems 202 and 302 of FIGS. 2 and 3. As shown in FIG. 4, chemical additive system 400 includes multiple assemblies 402. Each assembly 402 includes a chemical pump (e.g., 204), an electric motor (e.g., 206), and a flow meter (e.g., 210). Chemical additive system 400 includes a cabinet 404 (e.g., as described with respect to cabinet 208) that includes VFDs (e.g., 208A) and electronics (e.g., 208B). Chemical additive system 400 includes a temperature control unit 408, which is an optional component in some implementations of a chemical additive system. In some implementations, a temperature control unit includes one or more components configured to cool one or more components of the chemical additive system. For example, temperature control unit 408 can include an air conditioning unit. In some implementations, a temperature control unit includes one or more components configured to heat one or more components of the chemical additive system. For example, temperature control unit 408 can include a heating unit that enables the chemical additive system to operate at low ambient air temperatures. Chemical additive system 400 includes a generator 406 (e.g., as described with respect to generator 214). The components of a chemical additive system can be connected and configured as described above with respect to FIGS. 2 and 3.

As shown in FIG. 4, chemical additive system 400 includes a trailer 410 (e.g., a trailer chassis). The components of chemical additive system 400 are mounted to a trailer 410 for easy transport and maneuverability. In some implementations, the trailer is a standard length trailer (e.g., 48 to 53 feet in length). In some implementations, the trailer is shorter than standard length (e.g., between 16 and 48 feet in length). In some implementations, the components of a chemical additive system are mounted to a skid or pallet (e.g., instead of to trailer 410).

FIG. 5 is a flow chart showing aspects of an example process of pumping chemical additives. The example process 500 can be used, for example, to operate a chemical additive system, e.g., the example chemical additive system 202 or 302 in FIGS. 2 and 3. For instance, the example process 500 can be used to pump chemical additives at a specified chemical additive flow rate. The example process 500 may include additional or different operations, including operations performed by additional or different components, and the operations may be performed in the order shown or in another order. In some implementations, one or more operations in the example process 500 can be performed by a computer system, for instance, by a digital computer system having one or more digital processors (e.g., processor 610 in FIG. 6) that execute instructions (e.g., instructions stored in memory 620 in FIG. 6, forming a computer program 624).

At 502, the chemical additive system (e.g., 202) obtains a specified chemical additive flow rate for a fracturing slurry. In some implementations, the specified chemical additive flow rate is obtained via user input at a component of a chemical additive system (e.g., at a control panel of chemical additive system 202 of FIGS. 2 and 3). In some implementations, the specified chemical additive flow rate is obtained via an interface of a control system (e.g., embodied in electronics 208B of FIG. 2). For example, the flow rate can be obtained via a wired or wireless interface from an external source such as a data van, off-site control center, or from a cloud location. In such example, the specified flow rate can be specified via user input received or processed at the external source (e.g., by an operator in the data van).

At 504, the chemical additive system (e.g., 202) controls, using a VFD (e.g., 208A), motor speed of a motor (e.g., 206) for achieving the specified chemical additive flow rate. For example, a VFD 208A of chemical additive system 202 can be used to control the motor speed of electric motor 206. In some implementations, the chemical additive system controls multiple VFDs to control the motor speed of multiple electric motors for achieving the specified chemical additive flow rate. For example, a control system of the chemical additive system (e.g., in electronics 208B and/or onboard the VFD 208A) can cause (e.g., instruct) the VFD to output control signals having certain characteristics (e.g., amplitude and/or frequency) for controlling a coupled motor. In some implementations, the specified chemical additive flow rate is a target flow rate output of a single chemical pump or of a combination of multiple chemical pumps.

At 506, the chemical additive system (e.g., 202) drives, by a motor (e.g., 206), a chemical pump (e.g., 204) for achieving the specified chemical additive flow rate. For example, a VFD of the chemical additive system outputs control signals that cause the motor to rotate at a rotational speed configured to drive the chemical pump to discharge chemical additive at the specified chemical additive flow rate. In some implementations, the chemical additive system controls multiple motors to drive multiple chemical pumps for achieving the specified chemical additive flow rate.

At 508, the chemical additive system (e.g., 202) discharges, by the chemical pump, the chemical additive to the fracturing slurry (e.g., to blender 220). In some implementations, discharging the chemical additive includes providing the chemical additive to a blender trailer for addition to the fracturing slurry produced by the blender trailer. In some implementations, the chemical additive system discharges chemical additive from multiple chemical pumps to the fracturing slurry.

At 510, the chemical additive system (e.g., 202) measures, by a sensor (e.g., flow meter 210), a chemical additive flow rate from the chemical pump outlet. In some implementations, the chemical additive system measures multiple chemical additive flow rates at multiple chemical pump outlets. In some implementations, the chemical additive system uses the measured chemical additive flow rate in a feedback control loop (e.g., of a control system of electronics 208B or external to the chemical additive system). For example, the chemical additive system uses the measured chemical additive flow rate as feedback for adjusting control signals output by a VFD (e.g., control loop returns to 504 to control the VFD). For example, if the measured flow rate is lower than the specified flow rate, then the VFD can increase motor speed to increase pumping rate of the chemical pump; if the measured flow rate is higher than the specified flow rate, then the VFD can decrease motor speed to decrease pumping rate of the chemical pump.

FIG. 6 is a block diagram showing an example computer system 600 that includes a data processing apparatus and one or more computer-readable storage devices. Some of the components and/or functions described above can include and/or be performed by one or more features of computer system 600. For example, electronics 208B or the control systems described above can be performed using one or more features of computer system 600. The term “data-processing apparatus” encompasses all kinds of apparatus, devices, nodes, and machines for processing data, including by way of example, a programmable processor, a computer, a system on a chip, or multiple ones, or combinations, of the foregoing, e.g., processor 610. The apparatus can include special-purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code), e.g., computer program 624, can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors, e.g., processor 610, executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read-only memory or a random-access memory or both, e.g., memory 620. Elements of a computer can include a processor that performs actions in accordance with instructions, and one or more memory devices that store the instructions and data. A computer may also include or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a phone, an electronic appliance, a mobile audio or video player, a game console, a Global Positioning System (GPS) receiver, or a portable storage device (e.g., a universal serial bus (USB) flash drive). Devices suitable for storing computer program instructions and data include all forms of non-volatile memory, media, and memory devices, including by way of example, semiconductor memory devices (e.g., EPROM, EEPROM, flash memory devices, and others), magnetic disks (e.g., internal hard disks, removable disks, and others), magneto optical disks, and CD ROM and DVD-ROM disks. In some cases, the processor and the memory can be supplemented by, or incorporated in, special purpose logic circuitry.

The example power unit 640 provides power to the other components of the computer system 600. For example, the other components may operate based on electrical power provided by the power unit 640 through a voltage bus or other connection. In some implementations, the power unit 640 includes a battery or a battery system, for example, a rechargeable battery. In some implementations, the power unit 640 includes an adapter (e.g., an AC adapter) that receives an external power signal (from an external source) and converts the external power signal to an internal power signal conditioned for a component of the computer system 600. The power unit 640 may include other components or operate in another manner.

To provide for interaction with a user, operations can be implemented on a computer having a display device, e.g., display 650, (e.g., a monitor, a touchscreen, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to, and receiving documents from, a device that is used by the user; for example, by sending web pages to a web browser on a user's client device in response to requests received from the web browser, or by sending data to an application on a user's client device in response to requests received from the application.

The computer system 600 may include a single computing device or multiple computers that operate in proximity or generally remote from each other and typically interact through a communication network, e.g., via interface 630. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship between client and server may arise by virtue of computer programs running on the respective computers and having a client-server relationship with each other.

The example interface 630 may provide communication with other systems or devices. In some cases, the interface 630 includes a wireless communication interface that provides wireless communication under various wireless protocols, such as, for example, Bluetooth, Wi-Fi, Near Field Communication (NFC), GSM voice calls, SMS, EMS, or MMS messaging, wireless standards (e.g., CDMA, TDMA, PDC, WCDMA, CDMA2000, GPRS) among others. Such communication may occur, for example, through a radio-frequency transceiver or another type of component. In some cases, the interface 630 includes a wired communication interface (e.g., USB, Ethernet) that can be connected to one or more input/output devices, such as, for example, a keyboard, a pointing device, a scanner, or a networking device such as a switch or router, for example, through a network adapter.

In a general aspect, a chemical additive system pumps chemical additives for addition to a fracturing slurry.

In a first example, a method of providing chemical additives for hydraulic fracture treatments includes operating at least one (e.g., one or more) chemical pump installed on a chemical additive trailer to pump chemical additives from at least one chemical source to at least one blender trailer. Operating a chemical pump of the at least one chemical pump includes: receiving, at a pump inlet of the chemical pump, a chemical additive from a chemical source; discharging, at a pump outlet of the chemical pump, the chemical additive at a specified chemical additive flow rate, wherein the specified chemical additive flow rate is below 0.165 gallons per minute (gpm); and providing the chemical additive from the pump outlet to a blender trailer for addition to a fracturing slurry produced by the blender trailer. The method includes operating at least one electric motor installed on the chemical additive trailer to drive the at least one chemical pump. The method includes operating at least one variable frequency drive installed on the chemical additive trailer to control the at least one electric motor.

Implementations of the first example may include one or more of the following features. The specified chemical additive flow rate is between 0.084 gpm and 0.165 gpm. The at least one electric motor includes: a first motor having a first size; and a second motor having a second size different from the first size. The method further includes measuring a flow rate of the pump outlet of the chemical pump. While operating the at least one chemical pump, a fracturing slurry flow rate of the fracturing slurry produced by the blender trailer is between 20 barrels per minute (bpm) and 120 bpm. Operating the at least one chemical pump continuously while the fracturing slurry flow rate is between 20 bpm and 120 bpm. The chemical additive system includes a transformer that provides power to operate the at least one electric motor. The chemical additive system includes a generator that provides power to operate the at least one electric motor. The chemical additive is a viscosifier.

In a second example, a chemical additive system is configured to provide chemical additives for hydraulic fracture treatments. The chemical additive system includes a chemical additive trailer and at least one chemical pump installed on the chemical additive trailer. The at least one chemical pump is configured to pump chemical additives from at least one chemical source to at least one blender trailer. A chemical pump of the at least one chemical pump is configured to: receive, at a pump inlet of the chemical pump, a chemical additive from a chemical source; discharge, at a pump outlet of the chemical pump, the chemical additive at a specified chemical additive flow rate, wherein the specified chemical additive flow rate is below 0.165 gallons per minute (gpm); and provide the chemical additive from the pump outlet to a blender trailer for addition to a fracturing slurry produced by the blender trailer. The chemical additive system includes at least one electric motor installed on the chemical additive trailer and configured to drive the at least one chemical pump. The chemical additive system includes at least one variable frequency drive installed on the chemical additive trailer and configured to control the at least one electric motor.

Implementations of the second example may include one or more of the following features. The specified chemical additive flow rate is between 0.084 gpm and 0.165 gpm. The at least one electric motor includes: a first motor having a first size; and a second motor having a second size different from the first size. The system includes a flow meter configured to measure a flow rate of the pump outlet of the chemical pump. The chemical additive system includes a transformer that provides power to operate the at least one electric motor. The chemical additive system includes a generator that provides power to operate the at least one electric motor. The chemical additive system includes a housing installed on the chemical additive trailer; the housing houses the at least one variable frequency drive and electronics. The chemical additive system includes at least eight chemical pumps installed on the chemical additive trailer; the at least eight chemical pumps are configured to pump chemical additives from at least four distinct chemical sources to the at least one blender trailer. The chemical additive is a viscosifier. A first subset of the at least one chemical pump is configured to pump chemical additives from a first subset of chemical sources to a first blender trailer, and a second subset of the at least one chemical pump is configured to pump chemical additives from a second subset of chemical sources to a second blender trailer. Each of the at least one chemical pump is configured to pump chemical additives from a respective one of the chemical sources to the at least one blender trailer.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method of comprising:
operating at least one chemical pump installed on a chemical additive trailer to pump a chemical additive from a chemical source to a blender trailer, wherein operating a first chemical pump of the at least one chemical pump comprises:
receiving, at a pump inlet of the first chemical pump, the chemical additive from the chemical source;
discharging, at a pump outlet of the first chemical pump, the chemical additive at a specified chemical additive flow rate, wherein the specified chemical additive flow rate is below 0.165 gallons per minute (gpm); and
providing the chemical additive from the pump outlet to the blender trailer for addition to a fracturing slurry produced by the blender trailer;
operating an electric motor installed on the chemical additive trailer to drive the first chemical pump; and
operating a variable frequency drive installed on the chemical additive trailer to control the electric motor.

2. The method of claim 1, wherein the specified chemical additive flow rate is between 0.084 gpm and 0.165 gpm.

3. The method of claim 1, comprising:
operating a first electric motor to drive the first chemical pump, the first electric motor having a first size; and
operating a second electric motor to drive a second chemical pump of the at least one chemical pump, the second electric motor having a second size different from the first size.

4. The method of claim 1, comprising:
measuring a flow rate of the pump outlet of the first chemical pump.

5. The method of claim 1, wherein, while operating the at least one chemical pump, a fracturing slurry flow rate of the fracturing slurry produced by the blender trailer is between 20 barrels per minute (bpm) and 120 bpm.

6. The method of claim 5, comprising operating the at least one chemical pump continuously while the fracturing slurry flow rate is between 20 bpm and 120 bpm.

7. The method of claim 1, comprising, by operation of a transformer, transforming electric power provided to operate the electric motor.

8. The method of claim 1, comprising, by operation of a generator, generating electric power to operate the electric motor.

9. The method of claim 1, wherein the chemical additive is a viscosifier.

10. A chemical additive system comprising:
a chemical additive trailer;
at least one chemical pump installed on the chemical additive trailer, the at least one chemical pump being configured to pump a chemical additive from a chemical source to a blender trailer, wherein a first chemical pump of the at least one chemical pump is configured to:
receive, at a pump inlet of the first chemical pump, the chemical additive from the chemical source;
discharge, at a pump outlet of the first chemical pump, the chemical additive at a specified chemical additive flow rate, wherein the specified chemical additive flow rate is below 0.165 gallons per minute (gpm); and
provide the chemical additive from the pump outlet to the blender trailer for addition to a fracturing slurry produced by the blender trailer;
an electric motor installed on the chemical additive trailer and configured to drive the first chemical pump; and
a variable frequency drive installed on the chemical additive trailer and configured to control the at least one electric motor.

11. The system of claim 10, wherein the specified chemical additive flow rate is between 0.084 gpm and 0.165 gpm.

12. The system of claim 10, comprising:
a first electric motor configured to drive the first chemical pump, the first electric motor having a first size; and
a second electric motor configured to drive a second chemical pump of the at least one chemical pump, the second electric motor having a second size different from the first size.

13. The system of claim 10, comprising:
a flow meter configured to measure a flow rate of the pump outlet of the first chemical pump.

14. The system of claim 10, comprising a housing installed on the chemical additive trailer, wherein the housing houses the variable frequency drive and electronics.

15. The system of claim 10, comprising at least eight chemical pumps installed on the chemical additive trailer, wherein the at least eight chemical pumps are configured to pump a plurality of chemical additives from at least four distinct chemical sources to the blender trailer.

16. The system of claim 10, comprising a transformer that provides power to operate the electric motor.

17. The system of claim 10, comprising a generator that provides power to operate the electric motor.

18. The system of claim 10, wherein the chemical additive is a viscosifier.

19. The system of claim 10, comprising:
a first subset of chemical pumps configured to pump chemical additives from a first subset of chemical sources to a first blender trailer, and
a second subset of chemical pumps configured to pump chemical additives from a second subset of chemical sources to a second blender trailer.

20. The system of claim 10, comprising a plurality of chemical pumps configured to pump a plurality of chemical additives from a plurality of chemical sources to the blender trailer.
